(19) United States
(12) Patent Application Publication
(10) Pub. No.: US 2017/0174529 A1
(43) Pub. Date: Jun. 22, 2017

(54) FLOW POWERED WATER DISINFECTION

(71) Applicant: Aqua Access LLC, Albuquerque, NM (US)

(72) Inventors: Kevin Roderick, Albuquerque, NM (US); Rodney E Herrington, Albuquerque, NM (US)

(21) Appl. No.: 15/129,801

(22) PCT Filed: Mar. 28, 2015
(86) PCT No.: PCT/US2015/022807

§ 371 Date: Sep. 27, 2016

Related U.S. Application Data
(60) Provisional application No. 61/972,157, filed on Mar. 28, 2014.

(51) Int. Cl. C02F 1/00; F04F 5/04; C02F 1/78; F03B 17/06; C02F 1/32; C02F 1/467

(52) U.S. Cl. CPC C02F 1/008; C02F 1/32; C02F 1/4672; C02F 1/78; C02F 1/4674; F03B 17/061; F04F 5/04; C02F 2201/3228; C02F 2303/04; C02F 2201/009; C02F 2201/782; C02F 2201/3222; C02F 2209/40; F05B 2220/32; F05B 2220/706

(57) ABSTRACT

A turbine powered or solar powered disinfection system is incorporated in the main fluid line that is flowing to a point-of-use (POU) or point-of-entry (POE) water system or water storage tank. Disinfectant is added to the flowing fluid line or disinfectant energy is otherwise imparted to the flowing fluid line. Energy from the turbine or solar power source can be stored in a rechargeable battery or other energy storage device. The power for the disinfection system can be monitored and conditioned by a control system or power convertor. Said control system can incorporate diagnostics, operating instructions, alarms, remote control functionality, or integration with other control systems. Disinfection can be provided by a chlorine or mixed oxidant generation system, an ozone system, a chlorine dioxide system, an ultraviolet (UV) disinfection system, or other disinfection system.

### TECHNICAL FIELD

This invention is in the field of potable water systems and in particular concerns a water disinfection apparatus which derives power for its operation from the flow of water under pressure and provides disinfection to the flowing water stream.

### BACKGROUND

Effective water treatment generally comprises two processes, filtration and disinfection. The United States Environmental Protection Agency as well as the regulatory agencies of many countries requires that drinking water meet limits for clarity, typically measured by the cloudiness of the water and measured as Nephelometric Turbidity Units (NTU), and also that the water have an active disinfectant all the way to the drinking water tap. The active disinfectant standard since disinfection began in 1908 is chlorine. The World Health Organization has proven that chlorine is an effective intervention to save lives. Many programs and devices have been employed to treat water at the municipal level, as well as at the individual level. There are currently 1.2 billion people on the planet who do not have access to safe drinking water, people who are typically in developing countries.

In many countries, water may be available from a municipal source or from a local well, but power to pump the water to the point of entry (POE) may not be reliable. In millions of residences around the plant, water collection storage tanks are located in the house or apartment, or may be located on top of the building to provide gravity flow to the residence. During periods when power is available and pumps can operate, water is transferred to these storage tanks. Typically, water levels in the storage tank are controlled by float valves. Also, in many instances, the water may not be microbiologically safe—a disinfectant residual may not exist in the water. Water storage tanks can also form biofilm creating a microbiological hazard to the water.

Water disinfection systems use a variety of means for killing pathogens in a water supply, including addition of chlorine in many forms, such as ozone, ultra-violet light (UV), as well as others.

In areas where clean water is unavailable or unreliably available, as well as in areas where water is stored for long periods or re-used continually, disinfection and prevention of growth of microorganisms is an important concern for health, safety and facilities operation. Chlorine disinfection is a common disinfection method wherein chlorine, usually in the form of sodium or calcium hypochlorite, chlorine dioxide, or chloramines are added to water to kill microorganisms in the water.

Additionally, the use of such chemical means of disinfection is advantageous as it generally leaves a low concentration of the chemical as a residual in the water supply to provide ongoing disinfection. The presence of chlorine residual in the water indicates that both a sufficient amount of chlorine was added initially to the water to inactivate dangerous microorganisms and also that the water is protected from recontamination during storage. The U.S. EPA has set a maximum residual dosage level goal (MRDLG) of 4 ppm for chlorine residual in drinking water, and levels of ˜2 ppm are commonly targeted as providing adequate oxidant for disinfection while remaining below the MRDLG.

Because of the hazardous nature of the reactive chlorine chemistries used for chlorine disinfection, chlorine compounds are often produced locally (“on-site” generation) from less hazardous materials such as sodium chloride to avoid the dangers and costs associated with transporting hazardous chemicals.

Electrolytic technology utilizing dimensionally stable anodes (DSA) has been used for years for the production of chlorine and other mixed-oxidant solutions. Dimensionally stable anodes are described in U.S. Pat. No. 3,234,110 to Beer, entitled “Electrode and Method of Making Same,” whereby a noble metal coating is applied over a titanium substrate.

An electrolytic cell with dimensionally stable anodes is described in U.S. Pat. No. 4,761,208 to Gram, et al., entitled “Electrolytic Method and Cell for Sterilizing Water.”

Commercial electrolytic cells have been used routinely for oxidant production that utilizes a flow-through configuration that may or may not be under pressure that is adequate to create flow through the electrolytic device. Examples of cells of this configuration are described in U.S. Pat. No. 6,309,523 to Prasnikar, et al., entitled “Electrode and Electrolytic Cell Containing Same,” and U.S. Pat. No. 5,385,711 to Baker, et al., entitled “Electrolytic Cell for Generating Sterilization Solutions Having Increased Ozone Content,” and many other cells. In other configurations, the oxidant is produced in an open-type cell or drawn into the cell with a syringe or pump-type device, such as described in U.S. Pat. No. 6,524,475 to Herrington, et al., entitled “Portable Water Disinfection System.”

Many of the means of water disinfection require electrical energy in order to operate. On-site oxidant generation uses electricity to catalytically produce oxidant from an electrolyte, while both ozone generation for water treatment and direct UV sterilization use UV lamps. This electrical energy is generally provided by electrical utilities but also can come from locally generated sources (solar, wind, etc.) or via batteries or similar stored electrical energy in some cases.

Hydroelectricity, the generation of electricity from the energy of falling or moving water, is a widely known method for power generation. Large turbines used to generate power from dams are highly efficient (<90%) in converting the energy of moving water to electrical energy. Smaller hydroelectric generators are typically less efficient, but the same principles are employed to produce useable electricity from even very modest flows of water, in the range of L/min or smaller.

There is a need to provide improved and low cost point-of-use (POU) or point-of-entry (POE) water treatment systems that disinfect the water utilizing the energy from water flow in the piping (hydraulic), solar power, or other means rather than relying on conventional grid power.

### DESCRIPTION OF INVENTION

In some circumstances, such as remote locations, the energy required for water disinfection can be provided by converting kinetic energy of flowing water into electrical energy. By incorporating electrical power generation to produce disinfection, a self contained system can be realized, wherein the flowing water, or a portion of it, is disinfected while the water is flowing, without the need for external energy input. The kinetic energy required for the electrical generation can come from pump pressure from the water supply or from gravity head. Energy for the system can also be stored in rechargeable batteries or other devices. This stored energy can be used to generate a disinfectant in batch mode for subsequent use. The stored disinfectant can then be added to the flowing water stream by pumps powered from the stored energy devices, or from such sources as venturi educators located in the main water line that feeds the main water storage tank.

### BRIEF DESCRIPTION OF THE DRAWINGS

FIG. 1 is a schematic diagram of a turbine powered disinfection system with a brine source educted into an electrolytic cell.

FIG. 2 is a schematic diagram of a turbine powered disinfection system with a brine source educted into an electrolytic cell and an electrical circuit for conditioning power to the electrolytic cell.

FIG. 3 is a schematic diagram of a turbine powered disinfection system with a brine source and separate water source educted into an electrolytic cell and incorporating a control circuit.

FIG. 4 is a schematic diagram of a turbine powered disinfection system with an ozone generator that is powered from the turbine.

FIG. 5 is a schematic diagram of a turbine powered disinfection system with a ultraviolet light (UV) water sterilizing unit in the water flow line.

FIG. 6 is a schematic diagram of an electrolytic disinfection system powered by a hydraulically driven turbine and utilizing a batch chlorine disinfection system to disinfect a flowing water line.

### MODES OF CARRYING OUT THE INVENTION, AND INDUSTRIAL APPLICABILITY

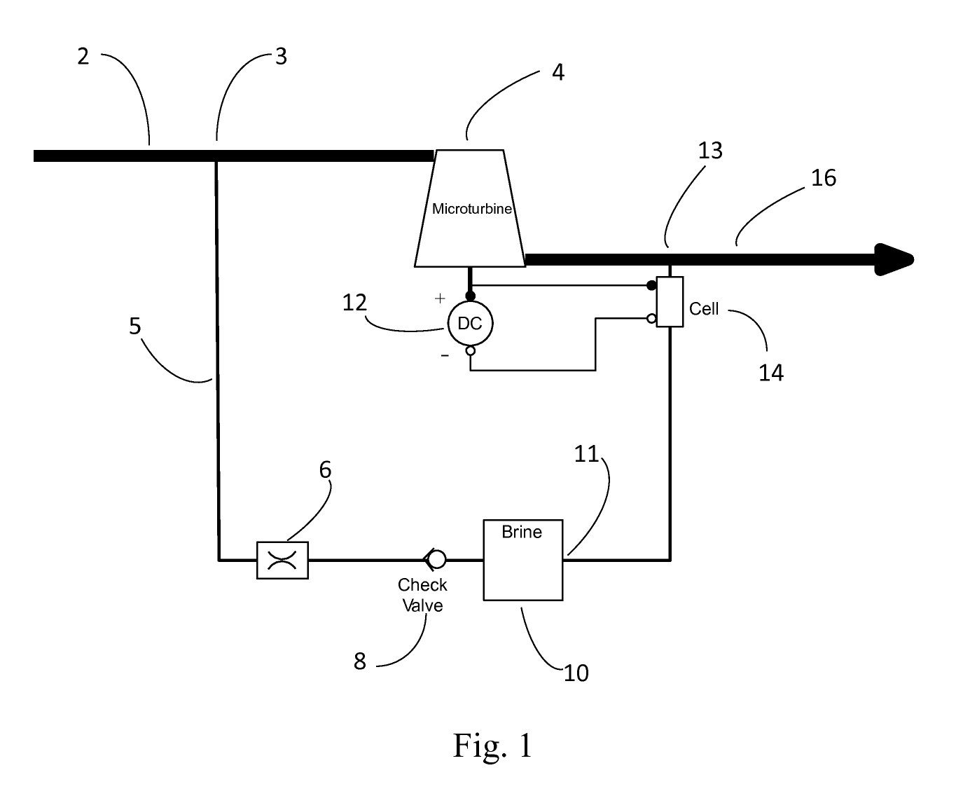

Example embodiments of the present invention provide a water disinfection system that provides advantages over the prior art. FIGS. 1-6 provide schematic illustrations of various example embodiments of the present invention, described in detail below.

Example embodiments of the present invention use the flow of water to generate electricity that is then used to disinfect the water either by electrolytic generation of disinfectant (such as chlorine or related disinfectants), or by generation of ozone or ultraviolet light to implement the disinfection of the flowing water. This capability is beneficial in areas where electric power is not readily available but pressurized water is available or can be easily produced (i.e. by pumping or lifting the water to provide head height). Applications involve windmill or solar powered wells, areas at the edge of water distribution networks where maintaining a continuous supply of water or chlorine residual in the water supply is difficult, and rooftop water storage tanks, cisterns, etc.

The amount of power produced by flowing water is directly proportional to the hydraulic head of the water (pressure) and to the efficiency of the hydroelectric generator at a given flow rate. With sufficient pressure driving the flowing water, enough electricity can be generated to provide adequate disinfection to the flowing water. Depending on the disinfection technology and its efficiency the energy required to produce adequate disinfection for water with current disinfection technology ranges from more than 30 Whr/m̂3 treated water for some ozone generators to less than 15 Whr/m̂3 treated water for electrolytic sodium hypochlorite generation or UV disinfection. An ideally efficient (100%) hydroelectric generator can produce 30 Whr/m̂3 at a pressure of 16 PSI, while a 25% efficient hydroelectric generator requires about 64 PSI to produce the same amount of energy from the same amount of water. Typical household water pressure in the U.S. is in the range of 45-65 PSI, which is sufficient to provide power for a disinfection system even with a low efficiency (25%) generator.

Electrolytic oxidant generators typically produce oxidant from a less hazardous feedstock. For example, sodium hypochlorite is generated from a sodium chloride solution through electrolysis. Such generators typically produce hypochlorite at concentrations in the 8-12% range. For water disinfection, this hypochlorite solution is diluted significantly to provide a final concentration of ≦2 mg/L residual in the water. Without high inlet water pressure it is possible to produce higher concentrations, but in most applications where water line or head pressure is less than 100 PSI, there is not significant power produced to produce higher concentrations of oxidant. Even with only a small head pressure, there is enough power to produce a final product oxidant stream of ˜2 mg/L or greater, which is sufficient for providing disinfection to the flowing water.

While oxidant can be produced from a dilute brine stream at low concentrations, the electrical efficiency is significantly reduced, so it can be advantageous to use a concentrated brine stream for oxidant production. Similarly, while the concentration of oxidant produced from the brine stream can be low, the higher amount brine that is converted into oxidant, the less brine is required for the production (a raw material cost) and the less residual brine must be added to the finished water to provide the proper level of disinfection. This can be important, as the level of sodium in potable water should not exceed 30-60 mg/L, and preferably should be below 20 mg/L, according to the US Environmental Protection Agency (EPA). The more dilute the oxidant in the brine, the higher the amount of sodium will be added to the water to produce an acceptable level of disinfectant in the water. As an example, the brine concentration within the electrolytic cell will range from 20-60 g/L, and the final oxidant content will be in the 2000-8000 mg/L range coming out of the electrolytic cell before being diluted down and mixed back with the main water flow.

In one embodiment shown in FIG. 1, the main flow of water 2 passes through micro turbine 4 to generate electricity from DC generator 12. A small portion of the flow is diverted through tee 3 to pass through flow regulator 6, then through check valve 8, and into inlet of brine generator 10, forcing brine out of outlet 11. Brine from outlet 11 flows through electrolytic cell 14, before feeding back into main water flow 16 through tee 13 after micro-turbine 4. Water flowing through micro-turbine 4 generates electricity to provide power to electrolytic cell 14, producing oxidant. Flow regulator 6 in brine feed line 5 is designed such that the proportion of water being converted to brine and electrolyzed results in the appropriate oxidant concentration, ideally ˜2 ppm, when it is returned and mixed with main water flow 16. In this case, brine generator 10 can produce saturated brine, which will cause a higher than optimum amount of residual sodium to be added back into main flow 16 and will use more salt than is required to produce the requisite level of oxidant. Alternately, brine generator 10 can be a source of diluted brine, for example with a salinity of <24 g/L in order to avoid adding excess sodium to the finished water and provide minimal salt usage.

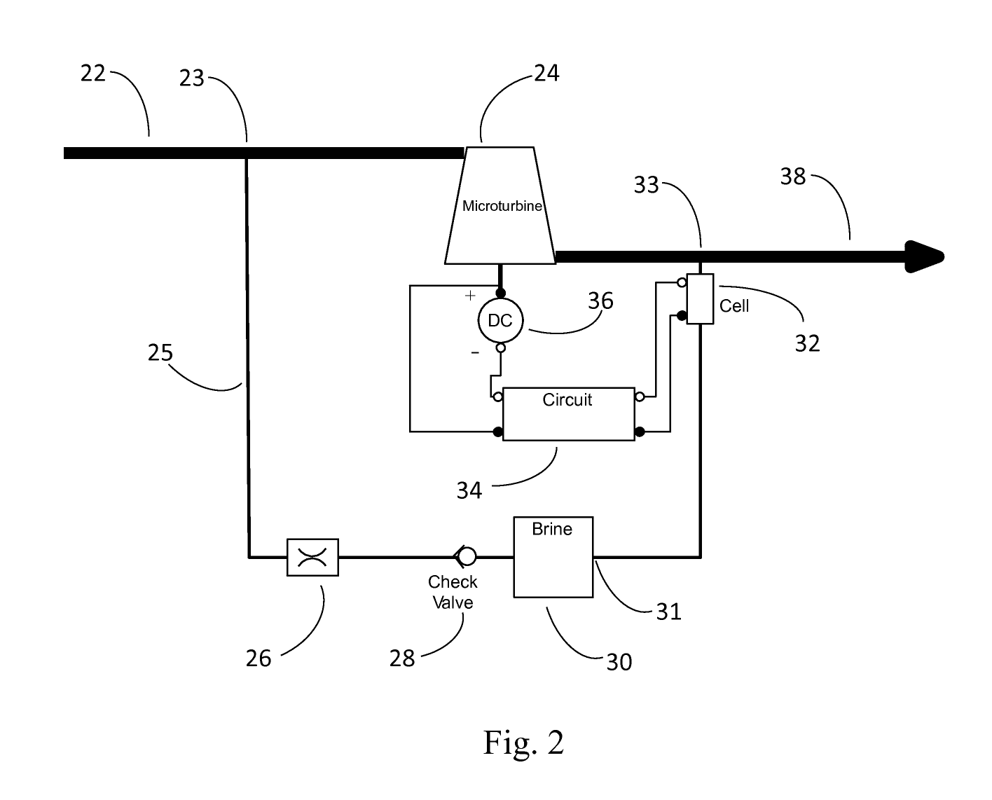

In another embodiment shown in FIG. 2, the main flow of water 22 passes through micro turbine 24 to generate electricity from DC generator 36. A small portion of the flow is diverted through tee 23 to pass through flow regulator 26, then through check valve 28, and into inlet of brine generator 30, forcing brine out of outlet 31. Brine from outlet 31 flows through electrolytic cell 32, before feeding back into main water flow 38 through tee 33 after micro-turbine 24. Water flowing through micro-turbine 24 generates electricity via DC generator 36 to provide power to electrolytic cell 32, producing oxidant. Flow regulator 26 in brine feed line 25 is designed such that the proportion of water being converted to brine and electrolyzed results in the appropriate oxidant concentration, ideally ˜2 ppm, when it is returned and mixed with main water flow 38. In this case, brine generator 30 can produce saturated brine, which will cause a higher than optimum amount of residual sodium to be added back into main flow 38 and will use more salt than is required to produce the requisite level of oxidant. Alternately, brine generator 30 can be a source of diluted brine, for example with a salinity of <24 g/L in order to avoid adding excess sodium to the finished water and provide minimal salt usage. Circuit 34 can be added between micro-turbine 24 and electrolytic cell 32 in order to raise or reduce the voltage produced by micro-turbine 24 to a level appropriate for electrolytic cell 32.

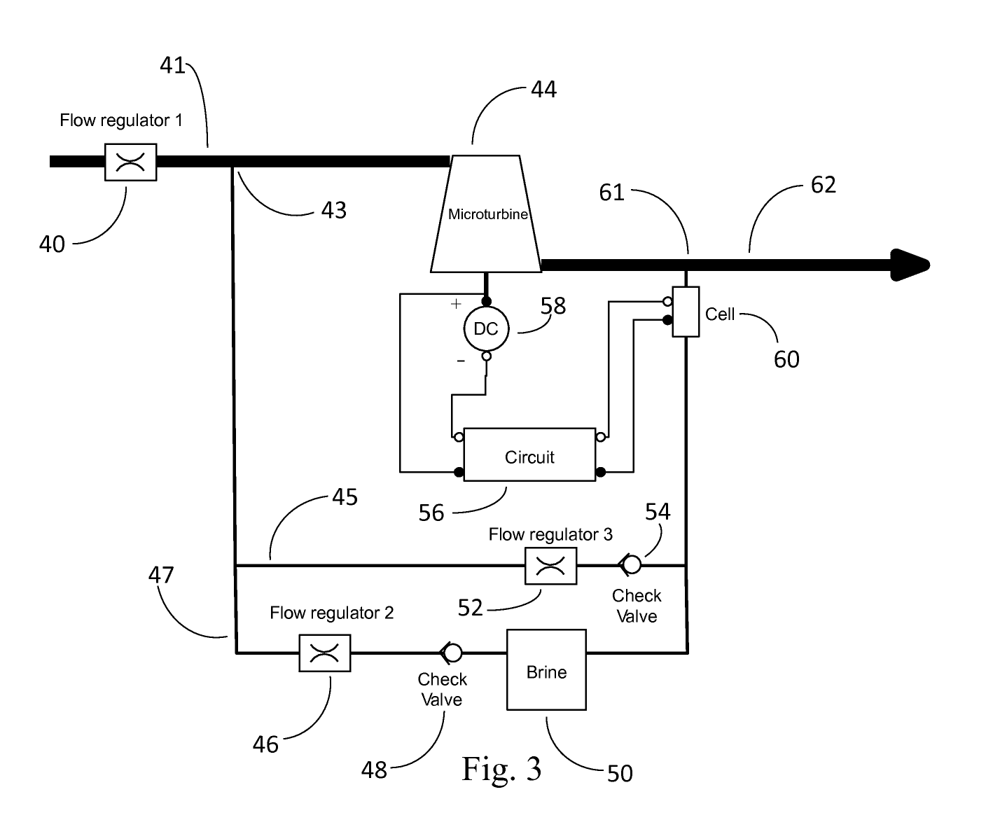

In another example embodiment shown in FIG. 3, main flow of water 41 passes through micro turbine 44 to generate electricity from DC generator 58. While water is flowing through micro turbine 44, the electricity generated provides power to electrolytic cell 60, producing oxidant. A small portion of flow 41 is diverted through tee 43 and split again into flow paths 45 and 47. Flow path 47 passes through flow regulator 46, through check valve 48, then into the inlet of a brine generator 50, forcing saturated brine out of the outlet before re-connecting with flow path 45, mixing, and flowing through electrolytic cell 60, before feeding back into main water flow 62 through tee 61 after micro-turbine 44. Flow path 45 passes through flow regulator 52 and check valve 54 then joins back with flow path 47 and mixes before entering electrolytic cell 60. Flow regulators 46 and 52 are specified such that when the saturated brine from brine generator 50 is mixed with the water in flow stream 45, the resultant diluted brine stream has a fixed salinity <24 g/L in order to minimize salt usage and result in an appropriate final oxidant concentration after electrolysis, for example about 2 ppm, when it is returned and mixed with main water flow 62.

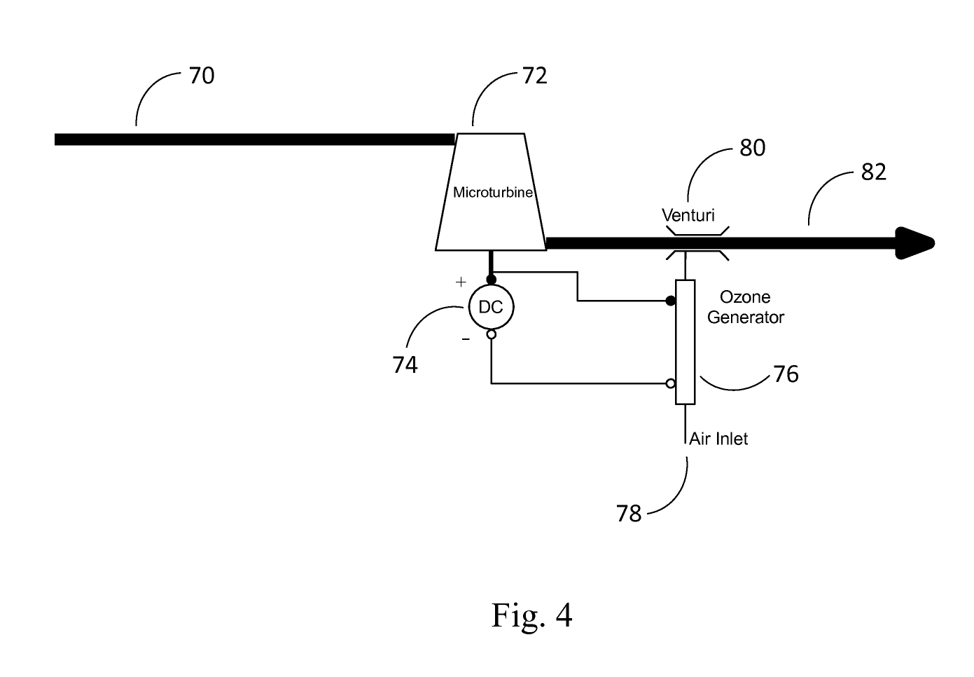

In another example embodiment shown in FIG. 4, the full flow of water 70 passes through micro-turbine 72 to generate electricity from DC generator 74. While water is flowing through micro-turbine 72, the electricity generated provides power to ozone generator 76. Ozone generator 76 is connected to the outlet flow of micro-turbine 72 through venturi fitting 80 which draws air in through air inlet 78, through ozone generator 76, entraining the generated ozone, and injecting the ozone-enriched air stream into the outlet flow. Venturi 80 is chosen in order to introduce an amount of ozone-enriched air to outlet flow 82 appropriate for disinfection, for example about 0.4 ppm.

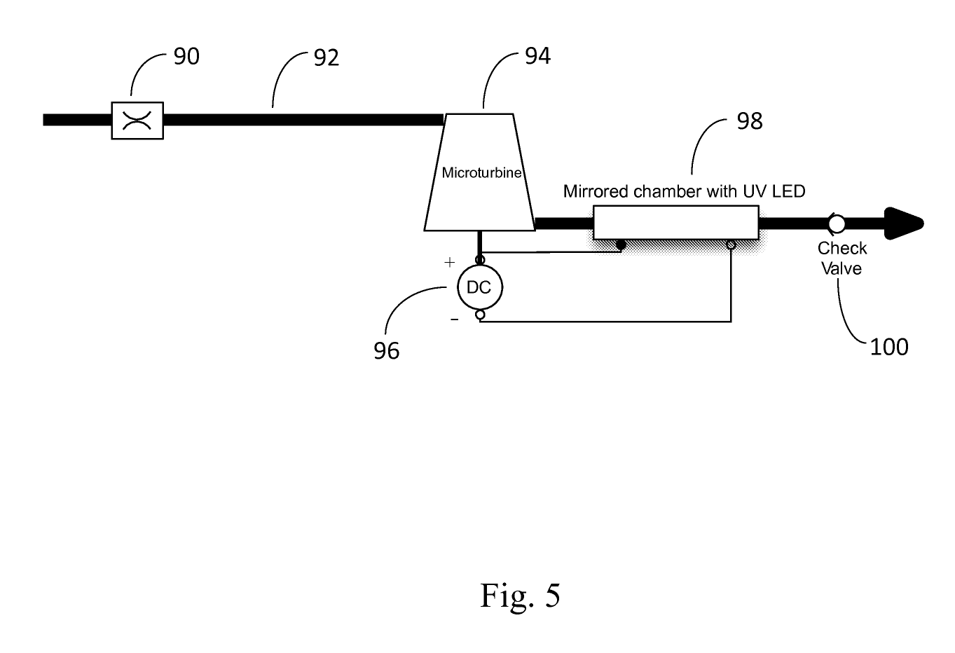

In another example embodiment shown in FIG. 5, the full flow of water 92 passes through flow regulator 90 and then through micro-turbine 94 to generate electricity from DC generator 96. While water is flowing through micro-turbine 94, the electricity generated provides power to mirrored chamber with UV LED 98. Mirrored chamber with UV LED 98 is connected to outlet flow of micro-turbine 94, All water in flow 92 passes through mirrored chamber with UV LED 98. Flow regulator 90 and size of mirrored chamber with UV LED 98 are chosen in order to allow the proper retention time for disinfection with UV light. Mirrored chamber with UV LED 98 is connected to check valve 100 to prevent backflow through the system.

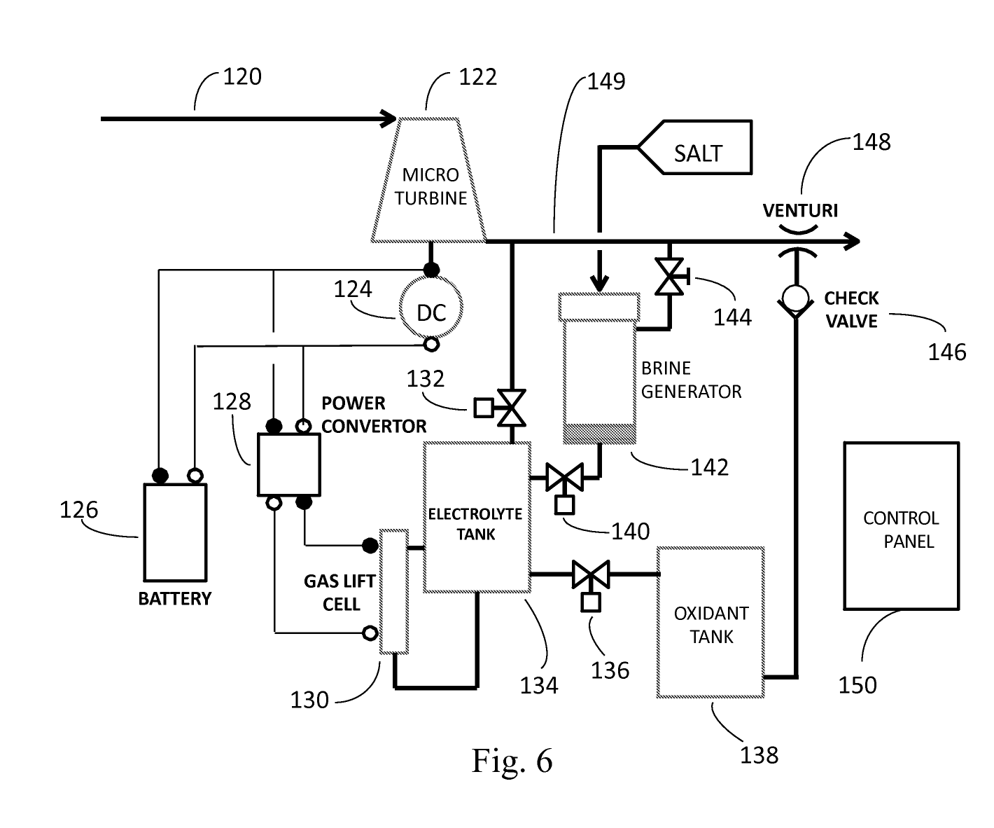

In another example embodiment shown in FIG. 6, micro-turbine 122 and DC generator 124 are attached to or additionally comprised of battery or capacitor 126 to provide temporary storage of the energy produced in order to allow batch production of oxidant or ozone which is less directly coupled to flow of water provide appropriate DC charge to electrolytic cell 130. Cell 130 in this case is configured to cause circulation of electrolyte solution via gas lift in cell 130 through electrolyte storage tank 134, As the electrolyte is circulated through cell 130, oxidant concentration is increased until the sodium chloride in the electrolyte solution is converted efficiently to oxidant. When power convertor and electrical circuit 128 has determined that sufficient chloride has been converted to chlorine, power to cell 130 is terminated. Solenoid valve 136 opens to allow transfer of the converted electrolyte solution to oxidant storage tank 138. Oxidant is drawn in to main water line 149 through check valve 146 via venturi educator 148 with flow roughly proportional to flow of water 149 through venture 148. In this configuration, sealed brine generator 142 receives water from main water line 149 through solenoid valve 144. Salt is converted to fully concentrated brine. During electrolyte makeup, a control timer allows the appropriate amount of water and brine to enter electrolyte tank 134 via solenoid valves 132 and 140 in order to make a new batch of electrolyte, and the process repeats. Control system 150 can provide a variety of functions to control the overall system. These include battery charging and monitoring system, notification of low or high battery condition, notification of low or no salt condition (to notify the user to add more salt, or to notify a customer service center to market and sell more salt to the user), notification of low oxidant condition, control of the proper power to the disinfection system and/or electrodes, notification of residual disinfectant value in the treated water, notification of disinfectant in the feed water (indicating that disinfection is not needed for the flowing water), control system fault, failure of the flow turbine to generate power, failure of the disinfectant system to produce disinfectant (including failure to produce chlorine, mixed oxidants, ozone, UV light, or other disinfectant), inadequate solar incident radiation to provide energy to power the energy storage device or disinfection device, Bluetooth connectivity to a remote control panel easily accessible to the user or customer service center, internet or other modem connectivity to a customer service monitoring station, Bluetooth or internet connectivity to a whole-house control system or integration into such whole house system, diagnostic instruction set for the user, graphic display control panel, and other control and alarm functions to facilitate ease of use for the user, or to otherwise make operation of the system transparent to the user. A control system can be incorporated to any level of sophistication in any of the embodiments defined herein.

The present invention can be further appreciated in view of the following publications, each of which is incorporated herein by reference.

U.S. Pat. No. 4,564,889 A—Flow powered light; U.S. Pat. No. 4,616,298 A—Water powered light; U.S. Pat. No. 6,885,114 B2—Miniature hydro-power generation system; U.S. Pat. No. 7,119,451 & related—Self powered UV disinfection; German Patent DE202006004800.

The present invention has been described in the context of various example embodiments. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. A system for the disinfection of water, comprising:
a power generator configured to produce electrical power from the flow of water, having a water inlet and a water outlet;
a disinfecting subsystem configured to accept electrical power from the power generator and to disinfect water from the outlet of the power generator.

2. A system as in claim 1, wherein the power generator comprises a turbine.

3. A system as in claim 1, wherein the disinfecting subsystem comprises:
a first flow regulator in fluid communication with the water inlet, and configured to allow a predetermined flow of water from an inlet to an outlet thereof;
a brine generator configured to accept water from the flow regulator and produce brine;
an electrolysis cell, configured to accept electrical power from the power generator and brine from the brine generator, and to produce a disinfectant and combine the disinfectant with water from the water outlet of the power generator.

4. A system as in claim 3, wherein the electrolysis cell comprises a circuit configured to adjust the voltage driving the electrolysis cell.

5. A system as in claim 3, wherein the disinfecting subsystem comprises a second flow regulator, configured to accept water from the water inlet of the power generator, and to mix water output from the second flow regulator with brine output from the brine generator such that the brine concentration provided to the electrolysis cell has a predetermined salinity.

6. A system as in claim 1, wherein the disinfecting subsystem comprises an ozone generator and a venturi, wherein the ozone generator accepts power from the power generator and produces ozone, and wherein the venturi is configured to entrain ozone-enriched air from the ozone generator into water flow before or after the water flows through the power generator.

7. A system as in claim 1, wherein the disinfecting subsystem comprises a reflective chamber and one or more ultraviolet light sources, wherein water flows though the reflective chamber before or after the water flows through the power generator, and wherein the ultraviolet light sources accept power from the power generator and supplies ultraviolet light to the reflective chamber, and wherein the ultraviolet light is of sufficient strength that water passing through the reflective chamber is disinfected.

8. A system as in claim 1, wherein the disinfecting subsystem comprises:
an electrical energy storage facility;
a brine generator configured to produce liquid brine from salt and water;
an electrolyte storage tank configured to receive a predetermined amount of brine and water;
an electrolytic cell, configured to accept power from the electrical energy storage facility and to cause a gas driven circulation in the electrolyte storage tank to convert the electrolyte to oxidant solution in batch mode;
an oxidant storage tank configured to accept oxidant from the electrolyte storage tank once the electrolyte has been converted to oxidant via electrolysis;
a venturi in water stream that provides output disinfected water, configured to generate a vacuum whereby oxidant from the oxidant storage tank is drawn into the water stream thereby adding disinfectant to the main water stream.

9. A system as in claim 8, further comprising a control system configured to monitor the supply of brine and to indicate an alert when the supply of brine reaches a predetermined threshold.

10. A system as in claim 8, further comprising a control system configured to monitor at least part of the system and to indicate an alert if a fault is detected.

11. A system as in claim 10, wherein the control system is configured to indicate the type of fault detected.
